(19) United States
(12) Patent Application Publication
(10) Pub. No.: US 2002/0142164 A1
(43) Pub. Date: Oct. 3, 2002

(54) Pitch plug for carbon electrode joint assembly

(76) Inventors: James Joseph Pavlisin, Cleveland, OH (US); Thomas William Weber, Cleveland, OH (US)

Correspondence Address: James R. Cartiglia, UCAR Carbon Company Inc., Suite 1100, 3102 West End Avenue, Nashville, TN, 37203, US

(21) Appl. No.: 09/821,990

(22) Filed: Mar. 30, 2001

(51) Int. Cl. B32B 9/00

(52) U.S. Cl. 428/408

(57) ABSTRACT

Plugs of pitch and intercalated graphite flakes that exfoliate when heated for graphite electrode joint assemblies. The plug may be inserted into the joint area of a graphite electrode assembly prior to assembly in the electrode column of an electrothermal furnace. Upon heating, the pitch melts and the treated flake exfoliates, forcing the pitch into the idle flank and void areas of the joint socket, increasing mechanical resistance, decreasing electrical and thermal resistance, and increasing joint locking mechanical strength. Also disclosed are composites comprising pitch and intercalated graphite flakes.

### FIELD OF THE INVENTION

This invention relates to pitch plugs that comprise pitch and intercalated graphite flakes, useful for joint assemblies for carbon, especially graphite, electrodes. The intercalated graphite flakes contained in the pitch plugs are capable of exfoliation upon heating. The plug may be inserted into the joint area of an electrode assembly prior to assembly in the electrode column of an electrothermal furnace. Upon heating, the pitch melts and runs, forcing the treated intercalated graphite flakes to flow with the pitch into the idle flank and void areas of the joint socket and expand, increasing mechanical resistance, decreasing electrical resistance, and increasing joint locking mechanical strength.

### BACKGROUND OF THE INVENTION

Carbon electrodes, especially graphite electrodes, are used in the steel industry to melt the metals and other ingredients used to form steel in electrothermal furnaces. The heat needed to melt the metals is generated by passing current through at least one electrode, usually three, and forming an arc between the electrodes and the metal. The heat that is developed by the electric arc not only melts the metal, but also gradually consumes the electrode. Because it is necessary to maintain a controlled arc length, the electrode used is present in a multiple-electrode column, and the electrode column must be fed down into the furnace to compensate for the electrode consumption. Therefore, it is necessary to continuously feed the electrode into the furnace in order to maintain the arc. Eventually, as the electrode is consumed, a new electrode section is added by joining it to the upper end of the old electrode section to form the electrode column.

A common method of joining the two electrode sections together is by use of a threaded nipple. The nipple is screwed into correspondingly threaded sockets provided in the end faces of the two electrode sections. Also, the nipple may comprise a machined threaded male surface at the end of the electrode. The opposite end of the electrode may have a threaded female surface to receive a corresponding male end. The threaded portions may be cylindrical.

In most applications a tapered, threaded nipple is used for its superior strength. The nipple may be made of the same material as the electrode or, if the nipple is a separate element of the electrode column, the nipple may be made of different material. The different material may include a higher quality graphite when compared to the graphite of the electrode such that the resistance will be lower in the joint area so as to not create a “hot spot” in the column.

This type of electrode column is both effective and popular in use, but has been the source of many problems. One such problem is the fact that the electrodes may occasionally at least partially unscrew from each other, which creates loose joints. The occurrence of loose joints can be a major problem resulting in high electrical resistance (which can create a “hot spot” and contribute to joint failure), increased electrode consumption, and weaker joints. Furthermore, loose joints are subject to increased vibration, which can contribute to mechanical failure.

Previous attempts have been made to solve this problem. For example, U.S. Pat. No. 2,828,294 to Johnson discloses a pitch-filled reservoir located within each end of the electrode nipple and channels to distribute melted pitch upon heating. The system was designed such that the pitch would fill the void spaces between the nipple and socket threads. Upon further heating, the pitch cokes or carbonizes, solidly cementing the joint and providing a stronger bond between the electrode sections. This method was not completely effective because vibration of the electrode column frequently overcame the resistance provided by the pitch coke.

Foaming agents that expand when heated have been added to the pitch to force the pitch out of the reservoir and provide better contact between the pitch and the threaded joint. For example, see U.S. Pat. No. 4,007,324 to Wallouch. However, the degree of swelling was limited and there appeared to be no dramatic effect on the coking reaction or time required to implement a bond between the nipple and the socket threads.

U.S. Pat. No. 4,725,161 to Dagata discloses a reservoir containing a cementitious bonding material comprising pitch particles and foaming agent selecting from the group consisting of sulfur, nitrated decant oil, 2,4-dinitroanoline and mixtures thereof. The cementitious bonding material may also include about 1 to 20 weight percent coarse particles of coke, carbon, or graphite to increase the unscrewing resistance of the pitch-covered joint prior to coking. The addition of sulfur was found to provide better coating and increased the bond strength between the nipple and the socket.

U.S. Pat. No. 4,729,689 discloses an electrode joint member with cementing pitch that is adhered to and/or impregnated within at least a portion of an electrode joint surface.

### SUMMARY OF THE INVENTION

It is an object of the present invention to provide a composite comprising particles of intercalated graphite and pitch. When exposed to high temperatures, the intercalated graphite flakes expand. The inventive composite may be in various forms, including plugs, pastes, solutions, slurries or powder. Preferably, the composite of the present invention is a plug that is disc-shaped.

It is another object of the present invention is to provide an electrode joint assembly, comprising a first and second carbon electrode segment having a threaded female surface and a threaded male surface, respectively. The male surface is engaged with the threaded female surface to form a threaded connection between the first and second carbon electrode segments. The joint further comprises a composite including pitch and intercalated graphite flakes that is located adjacent to the threaded surface. Preferably, an end of the threaded male surface defines a gap or cavity and the composite is in the form of a plug located adjacent to or in that gap or cavity.

In another embodiment of the invention, the threaded male surface may be portion of a separate element, such as a nipple, that engages the correspondingly threaded end portions of the first and second electrode sections. A gap is defined in either the first or second electrode section, or the nipple, such that the gap is adjacent the first or second electrode section, and a composite including pitch and intercalated graphite flakes is located adjacent to or in the gap. Alternatively, the composite is placed in the threaded end portion before the nipple is engaged.

Additionally, it is another object of the present invention to provide a method of forming a carbon electrode joint that includes a first and second carbon electrode segment and the composite of the present invention, comprising engaging a threaded male surface with a threaded female surface to form a threaded connection; and heating the first and second carbon electrode segments to melt the composite. As the composite melts, it disperses the pitch and graphite flakes into the idle flanks around the threads and void areas of the socket, including cavities as the intercalated graphite flakes expand.

The composites, joints and methods of the present invention enhance the carbon electrode column by providing increased joint locking mechanical strength, decreasing electrical resistance, and increasing thermal conductivity.

### BRIEF DESCRIPTION OF THE DRAWINGS

FIG. 1 shows a threaded nipple joint assembly of the present invention.

FIG. 2 shows a threaded nipple joint assembly of the present invention wherein the composite of the present invention is in the form of a plug and is received in a gap adjacent to the threads. Resistance before and after bake is also shown.

### DETAILED DESCRIPTION OF THE INVENTION

As stated above, an embodiment of the present invention is to provide an composite comprising particles of intercalated graphite and pitch. When exposed to high temperatures, the intercalated graphite flakes incorporated in the composite expand.

With respect to the pitch used to make the composites of the present invention, any pitch or pitch composition typically used in the carbon electrode art may be used as the pitch component of the present invention, as long as the pitch melting point temperature is below the exfoliation onset temperature of the graphite flakes, that is, the temperature at which the intercalated graphite flakes substantially begin to expand. This aspect of the invention is important because it is undesirable for the graphite flakes to expand before the pitch can flow and carry the flakes into the idle flanks and void areas of the joint. The exfoliation onset temperature can be readily determined by simply measuring the temperature at which the particles of intercalated graphite begin to expand or exfoliate.

The pitch of the present invention is derived from feedstocks comprising heavy aromatic petroleum streams, ethylene cracker tars, coal derivatives, petroleum tars, fluid cracker residues, pressure treated aromatic distillates, and combinations thereof. Preferably, the pitch is a coal tar pitch.

The production of pitch is described in, for example, the Encyclopedia of Chemical Technology, Kirk-Othmer, volume 23, pages 679-717, the contents of which are incorporated herein by reference.

Typically, the pitch of the present invention will begin to melt at about 105 degrees Celsius or below, and the intercalated graphite flakes will begin to expand at temperatures of about 160 degrees Celsius or higher.

The intercalated graphite flakes of the present invention are derived from crystalline graphite. The graphite flakes may be of an unexpanded size from about 0.1 millimeters to about 2.0 millimeters. The unexpanded graphite flakes preferably are of a size to pass through a 20 Tyler mesh sieve.

By treating the particles of graphite with an intercalent of, for example, a solution of sulfuric acid and nitric acid, the crystal structure of the graphite particles reacts to form a compound of graphite particles and the intercalent. Upon exposure to high temperature, the particles of intercalated graphite expand in dimension as much as at least about 80 and up to about 1000 times their original volume in an accordion-like fashion in the “C” direction, i.e., in the direction perpendicular to the crystalline planes of the particles of intercalated graphite. The exfoliated graphite particles are vermiform in appearance, and are therefore commonly referred to as worms.

The term “worm volume”, with units of cubic centimeters per gram (cc/g), is defined herein to mean the volume per mass unit of expanded graphite flakes obtained after heating and is commonly referred to as specific volume. The worm volume determination is made by placing the intercalated graphite flakes in a 900° C. nickel crucible placed over a Bunsen burner flame to cause exfoliation. The specific volume of the worms is then measured by transferring the worms to a graduated cylinder and normalizing the volume to the weight of the worms (cc/g). Worm volume is also referred to as expanded volume.

The typical worm volume for the expanded graphite flakes of the present invention is from about 80 cc/gm to about 1000 cc/gm, preferably about 250 cc/gm to about 500 cc/gm, more preferably about 400 cc/gm.

The high temperature at which the intercalated graphite flakes of the present invention begin to expand is typically at least about 150° C., and preferably from about 150° C. to about 250° C. or higher. Some expandable composites of the present invention may begin to expand at about 100° C.

Preferred graphite starting materials suitable for use in the present invention include crystalline natural graphite materials that are highly graphitic carbonaceous materials capable of reversibly intercalating alkali metals and expanding upon exposure to high temperatures.

The graphite starting materials used in the present invention may contain non-carbon components as long as the crystal structure of the starting materials maintains the required degree of graphitization.

A common method for manufacturing expandable graphite is disclosed in U.S. Pat. No. 3,404,061 to Shane, et al., the contents of which are incorporated herein by reference. In the typical practice of this method, natural graphite flakes are intercalated by dispersing the flakes in a solution containing an oxidizing agent, e.g., a mixture of nitric and sulfuric acid. The intercalation solution contains oxidizing and other intercalating agents known in the art. Examples include those containing oxidizing agent and oxidizing mixtures, such as solutions containing nitric acid, potassium chlorate, chromic acid, potassium permanganate, potassium chromate, potassium dichromate, perchloric acid, and the like, or mixtures, such as, for example, concentrated nitric acid and chlorate, chromic acid and phosphoric acid, sulfuric acid and nitric acid, or mixtures of a strong organic acid, e.g., trifluoroacetic acid, and a strong oxidizing agent.

A preferred intercalating agent is a solution of a mixture of sulfuric acid or sulfuric acid and phosphoric acid and an oxidizing agent, i.e., nitric acid, perchloric acid, chromic acid, potassium permanganate, hydrogen peroxide, iodic or periodic acids, or the like. Or, though less preferred, the intercalation solutions may contain metal halides such as ferric chloride, and ferric chloride mixed with sulfuric acid or halide, such as bromine or a solution of bromine and sulfuric acid or bromide and an organic solvent.

After the graphite flakes are intercalated, excess solution is drained from the flakes, and after washing with water, the intercalated graphite flakes are dried and can be expanded upon exposure to a flame for only a few seconds. Upon exposure to high temperature, the particles of intercalated graphite expand unrestricted in dimensions as much as about 80-1,000 or more times their original volume, typically in an accordion-like fashion. Commercially available expandable graphite flakes are available as GrafGuard™ expandable graphite flakes from Graftech Inc. of Lakewood, Ohio.

Production of intercalated graphite flakes is also discussed in U.S. Pat. No. 6,017,633 to Mercuri, the contents of which are incorporated herein by reference.

An expansion aid may be used prior to intercalation or during intercalation to reduce exfoliation temperature and increase worm volume.

An expansion aid in this context would be an organic material sufficiently soluble in the intercalant solution to achieve an improvement in expansion. More narrowly, organic materials of this type that contain carbon, hydrogen, and oxygen, preferably exclusively, maybe employed. Carboxylic acids are found effective in this regard. A suitable carboxilic acid as the expansion aid can be selected from aromatic, aliphatic, or cycloaliphatic, straight chain or branched chain, saturated or unsaturated, monocarboxylic acids, dicarboxylic acids, and polycarboxylic acids which have at least one carbon atom, and preferably up to about 10 carbon atoms, which is soluble and the aqueous intercalant solution employed according to the invention in amounts effective to provide a measurable improvement of more aspects of exfoliation.

The intercalant solution will be aqueous and will preferably contain an amount of expansion aid from about 1 to 10%, the amount being effective to enhance exfoliation.

The intercalant solution may be aqueous and may preferably contain from about 0% to about 15%, or more preferably about 10% water, by weight of the solution. In one preferred form, the aqueous intercalant solution comprises from about 75-90% sulfuric acid, about 5-15% of an oxidant such as nitric acid, the expansion aid comprises an amount effective to enhance exfoliation of from about 1-10% of a carboxylic acid solution in said aqueous intercalant solution, and the intercalant solution contains from about 0-15% water, also percentages based on the weight of the solution. In one embodiment where the expansion aid is contacted with the graphite flakes prior to immersing in the aqueous intercalant solution, the expansion aid can be mixed with the graphite flakes by suitable means, such as a speed V-blender, typically an amount of from about 0.2% to about 10% by weight of the graphite flakes.

The composite composition of the present invention may be made by a simple mixture of expandable graphite flakes and pitch, which can be broken up into sand-like particles. Optionally, the composition can be mixed under pressure.

The plugs of the present invention comprising the expandable composite composition of the present invention can be made with a high pressure press. Additionally, the plugs of the present invention can be made by warming the above mixture to about 80% of the melting point of the pitch and shaping the warmed mixture into a plug before the mixture cools.

Preferably, the inventive composite comprises about 60 to 80 percent pitch and about 20 to 40 percent intercalated graphite flakes (by weight). More preferably, the composite is about 70 percent pitch and about 30 percent intercalated graphite flakes.

As stated above, a common method of joining the two electrode sections together is by using a separate, threaded nipple. The nipple is screwed into a correspondingly threaded socket provided on the end faces of the two electrode sections. As stated above, the nipple comprises a threaded male surface at the end of one electrode, or it may comprise a separate unit that is connected to corresponding threaded sockets provided in the end faces of the two electrode sections. In the latter embodiment, the nipple (or electrode pin) is a separate unit that functions to join the end of adjoining electrodes. Typically, the pin takes the form of opposed male threaded sections, with at least one end of the electrode comprising female threaded sections capable of mating with the male threaded section of the pin. Thus, when each of the opposing male threaded sections of the pin are threaded in the female threaded sections in the ends of two electrodes, those electrodes become joined into an electrode column. In this embodiment, the nature of the pin is not known to be critical as long as it functions to properly join the electrodes, which is within the skill of the art. U.S. Pat. No. 5,415,755 to Wise describes such a pin.

The present invention further comprises a joint assembly comprising a first carbon electrode segment having a threaded female surface and a second carbon electrode segment having a threaded male surface engaged with the threaded female surface of the first carbon electrode segment to form a threaded connection between the first and second carbon electrode segments. The threaded male surface may be a separate nipple or pin that has previously engaged the first electrode segment and is subsequently engaged with the second electrode segment. The joint assembly of the present invention further comprises a composite including pitch and intercalated graphite flakes, which is located adjacent to one of the threaded surfaces.

The composite of the present invention may be in the form of a solid plug. Preferably, it is in the form of a plug or disc and is located within a gap defined by a portion of the threaded male surface. However, all that is required is that the composite be located adjacent to or interior to a threaded surface (within a gap or otherwise) so that, when heated, the composite fills the void cavities within the joint.

In one embodiment of the invention the composite is contained in at least one point along a central axis of the threaded male surface or at one point along a outer surface of the threaded male surface.

Additionally, there will typically be a gap between the threaded male surface and the corresponding threaded female surface after the two are engaged. In one embodiment of the present invention, the composite may be placed in or on one of the threaded surfaces before engagement with the other threaded surface so that the composite is received in the gap between the threaded male surface and the corresponding threaded female surface.

The present invention further comprises a method of forming an electrode segment. The method comprises providing a first carbon electrode segment having a threaded female surface described above and providing a second carbon electrode having a threaded male surface described above. Furthermore, the composite including pitch and intercalated graphite flakes is described above and is incorporated into the joint adjacent to a threaded surface. The threaded male surface is engaged with the threaded female surface to form a threaded connection; and the first and second carbon electrode segments are heated to melt the pitch and expand the intercalated graphite flakes, facilitating sealing of the threaded connection.

The heat required for expansion typically occurs from heat generated from being adjacent to the furnace, before being lowered into the furnace. The plug may be loaded in one plug socket of the nipple or gap of the joint assembly before assembly of the electrode column or the other plug socket of the nipple or gap of the joint assembly as the columns are built before entry into the furnace. The nipple and plug or paste may be preset in one gap or plug socket at the factory or other assembly point before the column is completely assembled before entry in the furnace.

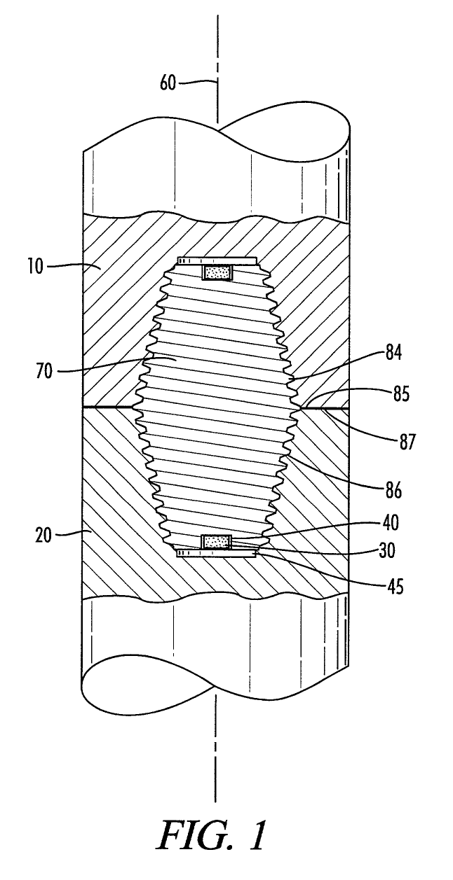

Turning now to the drawings, FIG. 1 represents an electrode joint assembly of the present invention. The abutting ends 85, 87 of the opposed electrodes 10 and 20, are aligned along a central longitudinal axis 60. Also aligned along the central axis 60 is a threaded nipple 70 that has threads 84 that are received by the grooves of the threaded female surface 86 of the electrode. In this embodiment, on either side of the nipple is a gap 45. The expandable composite composition of this embodiment is in the form of a plug 30 that is received by a plug socket 40, part of the gap located adjacent to the threaded surface.

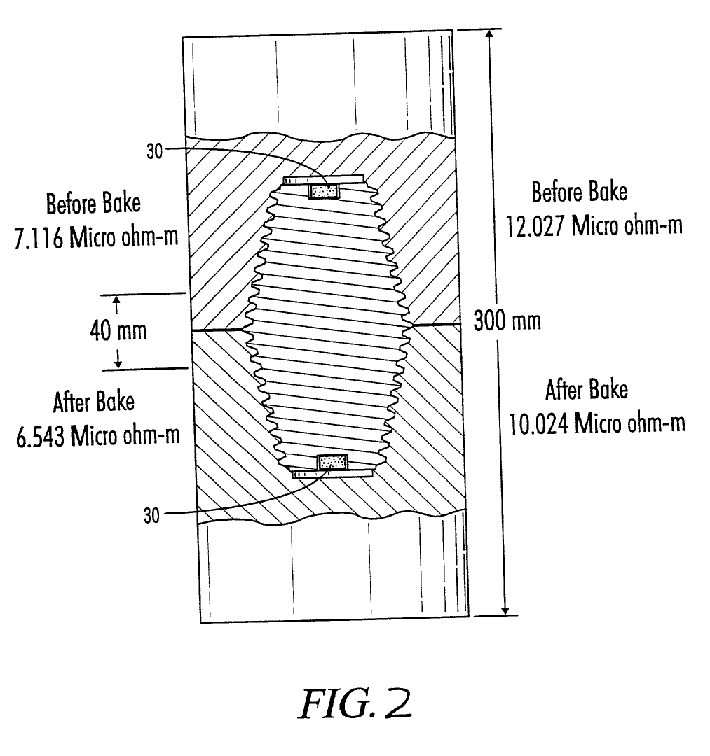

In FIG. 2, the expandable composite composition is in the form of a disc placed in a gap at both ends of the nipple, a preferred embodiment of the present invention. Before an electrode bake, the area 20 mm in each direction (along a central axis) from the abutting ends shows an resistance of 7.116 micro ohms-m. After the bake, the resistance is 6.543 micro ohms-m. In an area 150 mm in each direction (along a central axis) from the abutting ends of the electrodes shows a resistance of 12.027 micro ohms-m before the bake and 10.024 micro ohms-m after the bake. This embodiment shows improved resistance.

All cited patents and publications referred to in this application are herein expressly incorporated by reference.

This invention thus being described, it will be obvious that the same may be varied in many ways. Such variations are not to be regarded as a departure from the spirit and scope of the present invention, and all such modifications as would be obvious to one of ordinary skill in the art are intended to be included within the scope of the following claims.

We claim:

1. An expandable composite comprising:
intercalated graphite flakes and pitch;
wherein the composite expands when exposed to high temperatures.

2. The expandable composite of claim 1, wherein said pitch is coal tar pitch or petroleum pitch.

3. The expandable composite of claim 1, wherein said intercalated graphite flakes expand at least about 80 times the original volume when exposed to high temperatures.

4. The expandable composite of claim 1, which comprises about 60 to about 80 percent pitch and about 20 to about 40 percent intercalated graphite flakes by weight.

5. The expandable composite of claim 1, wherein the pitch melting point is lower than the exfoliation onset temperature of the intercalated graphite flakes.

6. The expandable composite of claim 1, wherein the exfoliation onset temperature of the intercalated graphite flakes is at least about 150 degrees Celsius.

7. The expandable composite of claim 1, wherein the composite is a solid plug.

8. The expandable composite of claim 7, wherein the composite is in the form of a disc.

9. A joint assembly, comprising:
a first carbon electrode segment having a threaded female surface;
a second carbon electrode segment having a threaded male surface engaged with the threaded female surface of the first carbon electrode segment to form a threaded connection between the first and second carbon electrode segments; and
a composite including pitch and intercalated graphite flakes, the composite located adjacent to the threaded surface of either the first carbon electrode segment or the second carbon electrode segment.

10. The joint assembly of claim 9, wherein said composite is adhered to at least one threaded surface.

11. The joint assembly of claim 9, wherein one of said carbon electrode segments comprises a gap, said gap containing said composite.

12. The joint assembly of claim 9, wherein said pitch is derived from feedstocks comprising heavy aromatic petroleum streams, ethylene cracker tars, coal derivatives, petroleum tars, fluid cracker residues, pressure treated aromatic distillates, and combinations thereof;
the intercalated graphite flakes have a worm volume of at least about 80 cc/g when exfoliated; and
the ratio of pitch to graphite flake is about 60 to about 80 percent pitch and about 20 to about 40 percent graphite flake by weight.

13. The joint assembly of claim 9, wherein the threaded male surface is a separate, integral threaded pin that engages a threaded socket in the second carbon electrode segment.

14. An electrode joint for connecting two electrodes, comprising:
a first electrode section having a threaded end portion;
a second electrode section having a threaded end portion;
a threaded nipple that engages the correspondingly threaded end portions of the first and second electrode sections;
a gap defined by said nipple adjacent to the first or second electrode section; and
a composite including pitch and intercalated graphite flakes located adjacent to the gap.

15. The electrode joint of claim 14, the composite being a plug in the shape of a disc.

16. The electrode joint of claim 14, the composite being received by the gap.

17. The electrode joint of claim 14, wherein the composite has a pitch/intercalated graphite flakes ratio of about 60-80 percent pitch and about 20-40 percent intercalated graphite flakes; and
the pitch melting point is lower than the exfoliation onset temperature of the intercalated graphite flakes.
